(19) United States
(12) Patent Application Publication
(10) Pub. No.: US 2018/0293672 A1
(43) Pub. Date: Oct. 11, 2018

(54) CONTROL TOWER PRODUCTION METHOD FOR CROP FRACTIONS AND DERIVATIVES

(71) Applicant: Morris JOHNSON, Regina (CA)

(72) Inventor: Morris JOHNSON, Regina (CA)

(21) Appl. No.: 15/768,734

(22) PCT Filed: Oct. 13, 2016
(86) PCT No.: PCT/CA2016/051191

§ 371 Date: Apr. 16, 2018

(30) Foreign Application Priority Data
Oct. 14, 2015 (CA) 2902766
Feb. 22, 2016 (CA) 2921553

(51) Int. Cl. G06Q 50/02; G06Q 10/08; G06Q 40/04; A01C 1/06; A01C 21/00; A01D 41/12; A01D 47/00

(52) U.S. Cl. CPC G06Q 50/02; G06Q 10/0838; G06Q 40/04; A01D 47/00; A01C 21/00; A01D 41/1243; A01C 1/06

(57) ABSTRACT

A control tower crop production method for the production of processed crop products from crop material. A control tower entity enters into a plurality of presale contracts and supply contracts, to purchase sufficient crop material with at least one supplied material characteristic to allow for processing of same into an aggregate product sold quantity amount of crop material fractions or crop material derivatives. Controlling the quantity and character of the crop material purchased will allow for precise acquisition of feed stock for the preparation of a required amount of processed crop products. Various processing methods for the processing and fractionation of crop material including hemp grain, are also disclosed. In addition to the control tower crop production method executed by the control tower entity, a method of production of crop material by a crop producer for use in a control tower crop production method is also disclosed.

### BACKGROUND

This invention is in the field of agricultural crop production methods and products therefrom. More specifically, the invention comprises a control tower crop production method for the production of processed crop products from crop material produced by at least one crop producer, where key parameters of the production process from generation of the crop material through to the completion of the processed crop products are controlled by a control tower entity.

### BACKGROUND OF THE INVENTION

Innovation of many types is taking place in agricultural production as in many other industries. More and more agricultural producers are becoming engaged in the production of specialty crops, and are producing crops under to the system production parameters for use in various food, medical and other applications. Coordination of the production of large quantities of such material, either by individual or cultural producers or in larger aggregated groups, becomes more complicated task as the level of complexity and detail in these individual crop production tasks increases. Particularly as the demand for food increases in the world, the need for agricultural producers to be able to undertake larger aggregate production jobs, to satisfy the demand for a large quantity orders of agricultural products, is ever-increasing. Any method of logistics coordination which can assist in these types of tasks use it is believed commercially attractive in the current state of the agricultural production economy.

One area in which extreme complexity exists is the production of crop material or finished crop fractions or crop derivatives in cases where either the raw crop material or the finished crop products are subject to legislative restrictions or regulations. For example in some cases the actual production of raw crop material is regulated, and in other cases raw crop material can be grown or produced, but processing and the subsequent derivative products may be tightly regulated. This added layer of regulatory complexity is again an issue which if it could be dealt with in some type of an agricultural production method is believed would be favourably received in the commercial marketplace.

In addition to these types of regulatory restrictions, larger aggregated quantities of raw crop material can be processed into multiple fractions or derivative products, with different finished product characteristics depending upon the purchaser's needs—for example multiple types of fractions can be created from a particular type of raw crop material, or the same type of fraction can be created or refined to a different purity level or active ingredient level for example, depending upon the desires of the customer. A “field-to-consumer” agricultural product production method would be accepted in industry.

One example of this type of a regulatory scenario in which it is believed that an enhanced production method which would accommodate these types of raw crop material or finished crop products regulatory restrictions is the production of crops that have regulated active ingredients, such as hemp. Over the last hundred years, hemp has evolved from a widely available multi-use crop to a highly regulated poorly utilized crop. This invention seeks to remove dysfunctionality from the state of the art of commercial activity that centers on the non THC cannabinoid and terpene bio-actives originating in the industrial hemp plant. Currently non-THC cannabis terpenes and cannabinoids science cannot be commercialized to the extent that consumers demand. Industrial hemp cannabis bio-actives when not presented as drugs containing THC, present as food, nutritional supplements, medicinal foods, natural health products, cosmetics, animal supplements and such other categories that government regulators choose to place them within.

A control tower production method could be developed that would accommodate many of the issues associated with these types of complicated agricultural production scenarios. A control tower production method is a method of manufacture or production used in many different industries that centers around controlling all of the key or critical control points in a manufacturing process to guarantee process performance or product quality or output. In the particular context of hemp production, there are several supply chain critical control points in an integrated field to consumer industrial hemp cannabis bio-actives supply chain that could benefit from the application of a control tower management methodology, including to minimize incursion by government regulators into such activities. These critical control points include supply contracts for the production and delivery of crop material, prescribed crop management practices including harvesting methods, novel processing and extraction methods and consumer/consumer representative driven field to consumer supply contracts. Management using these critical control points will enable cannabinoid and terpene bioactive commercialization in foods AND non-drug formulations within existing government regulations.

### BRIEF SUMMARY

Industrial hemp cannabis bioactives for use in functional food, nutraceutical and related non-drug applications in Canada are accessed via a fragmented supply chain regulated by several government agencies. The present invention discloses a production method which can be used in the production of processed crop products from hemp or other crop material, whereby the supply chain is not unduly restricted in efforts to develop large scale commercial activities based on the unmet needs of consumers. The supply chain critical control points integrate farmer, processor and marketing and consumer centric activities. Food, nutraceutical and other non prescription pharmaceutical medicinals sourced from industrial hemp cannabis bioactives are within the scope of this invention. This invention does not relate to oil, meals or proteins presented as simple foods which do not contain measurable amounts of other functional cannabis bioactives.

The invention, a control tower crop production method for the production by a control tower entity of processed crop products from crop material, accomplishes its objectives in one embodiment comprising a series of steps undertaken by a control tower entity. The first step in this embodiment of the method and the invention comprises the control tower entity entering into at least one presale contract for the sale to at least one purchasor of a quantity of processed crop products having at least one sold product characteristic. The aggregate of the quantity of processed crop products for all of the presale contracts is the aggregate product sold quantity.

The next step in the method is for the control tower entity to enter into at least one supply contract with at least one crop producer for the purchase and delivery to the control tower entity at a prescribed delivery time of a quantity of supplied crop material having at least one supplied material characteristic. The aggregate of the quantity of supplied crop material for all of the supply contracts being the aggregate material supply quantity. Basically, the control tower entity will contract for the purchase of a sufficient aggregate material supply quantity of crop material to allow for production of the required aggregate product sold quantity of processed crop products.

For each supply contract, the control tower entity would take delivery at the prescribed delivery time of the quantity of supplied crop material contracted thereunder, such that when all of the crop material contracted from all the crop producers was received, the control tower entity would have in their control the aggregate material supply quantity of crop material. Upon completion of delivery and acceptance of the aggregate material supply quantity, the control tower entity would then process the crop material into processed crop products with the at least one supplied material characteristic required by each of the at least one presale contract the processed crop products for each presale contract to the corresponding purchasor The aggregate material supply quantity contracted for with the at least one crop producer is a sufficient quantity of supplied crop material having adequate at least one supplied material characteristic to produce the quantity of processed crop products.

Certain embodiments of the control tower crop production method of the present invention would allow the at least one crop producer to simply produce the quantity of supplied crop material contracted for in accordance with their own desired methods, so long as the at least one supplied material characteristic are met in the crop material delivered. In other cases, the at least one supply contract might specify prescribed crop management practices under which the crop material is to be processed. Both such approaches are within the scope of the present invention.

Many different types of prescribed crop management practices could be used or specified in the production of the aggregate material supply quantity of crop material depending upon the desires or needs of the control tower entity. These include:
treating the planting seeds and spraying the growing crop foliage with at least one plant growth regulator;
specifying the harvest timing for the crop material such that the weight of oilseed meat to hemp grain plant matter exceeds 50.1%;
swathing the hemp crop stock and drying the swath in advance of further harvest processing to minimize time/temperature dependent spoilage;
using harvesting equipment to gather only the heads of the hemp plants into bulk containers in the field for further processing;
harvesting the hemp grain using a combine harvester set to remove only the hemp plant stalks from the remainder of the crop material for return to the field; or
delivery of aggregated bin run hemp grain material as crop material.

It is specifically contemplated that one of the primary elements of at least one supplied material characteristic to be desired in crop material contracted for delivery is that the crop material sold under a supply contract includes a prescribed range of content of an active ingredient therein. The range of active ingredient content might include a prescribed threshold value for the content of an active ingredient therein being either a ceiling or a floor value. All such approaches are contemplated within the scope of the present invention.

In addition to specifying at least one supplied material characteristic, the presale contracts might also stipulate at least one sold product characteristic for the processed crop products purchased. Again these at least one sold product characteristic might be many different qualities or parameters of the processed crop products, including active ingredient values or the like. It will be obvious to those skilled in the art of grain processing and bioactive and nutraceutical food design that there could be many different product parameters within the scope of the at least one sold product characteristic and all are contemplated within the scope hereof.

Many different methods of processing crop material into processed crop products, being fractions, derivatives or otherwise, are all contemplated within the scope hereof and will all be understood to those skilled in the art of seed processing—for example, one approach could comprise fractionating the crop material into a plurality of midstage fractions which can be further processed into processed crop products; and refining the midstage fractions to yield the quantity of processed crop products with the desired at least one sold product characteristic. Any method of fractionating or otherwise processing the quantity of supplied crop material into any type of desired processed crop products is understood to be within the scope of the invention.

The control tower entity might be responsible for the crop material processing step, or might additionally enter into at least one processing contract with at least one processor to assist in the processing of crop material.

Insofar as the control tower crop production method herein matches the aggregate material supply quantity with the requirements to produce the aggregate product sold quantity, the presale contracts could be completed in advance of the completion of the supply contracts, and the number of supply contracts and the details of the at least one supplied material characteristic of the aggregate material supply quantity required is selected based on the quantity and quality of the aggregate product sold quantity sold by the control tower entity under the presale contracts. Conversely the supply contracts could be completed in advance of the completion of the presale contracts, and the number of presale contracts and the aggregate product sold quantity is selected based upon the quantity and quality of the aggregate material supply quantity available to the control tower entity under the supply contracts. Any number of supply contracts or presale contracts could be used in the practice of the method.

The crop material used in the method of the present invention could be plant matter, including plant seed. It is specifically contemplated that the method would be useful in the aggregated production and processing of hemp grain, but other crops and plant matter could also be used.

The processed crop products sold to a purchasor in a supply contract could be crop material fractions, or could also be crop material derivatives or some combination thereof.

Many types of processing or extraction methods could be used in the production of processed crop products from crop material in accordance with the method outlined herein. For example, solvent extraction could be used to extract or strip certain components from the crop material. In some cases it might be deemed beneficial to allow at least a portion of the solvent used in the solvent extraction process is left in the related quantity of finished crop material derivatives, whereas in other methods the solvent would be removed therefrom. One solvent which is specifically contemplated for use with the solvent extraction of active ingredients and fractions from hemp grain is dimethyl sulfoxide, although it will be understood that many other types of solvents could also be used and are all contemplated within the scope of the present invention.

Where the crop material being grown or used is hemp grain, the processing techniques for the crop material might include air or mechanical fractionation of crop material based hemp bioactive concentrations; threshing raw plant material to separate remaining stalks, and macerating remaining raw crop fraction into particulate for further processing; crushing crop material for oil, said oil having a higher CBD concentration than spent crushed hemp grain; heating the hemp grain to a temperature between the heat of vaporization and heat of decomposition of CBD, to generate a vapor that is condensed into a purified CBD fraction and a spent hemp grain fraction which is depleted of CBD; or solvent extraction of derivatives from the crop material.

The processed crop products produced in accordance with any embodiment of the method hereof are also contemplated within the scope of the invention.

In addition to the control tower crop production method disclosed, there is also outlined herein a method of production of crop material by a crop producer for use in a control tower crop production method for the production of processed crop products from crop material, said method comprising the crop producer:
entering into a supply contract with a control tower entity for the sale and delivery to the control tower entity at a prescribed delivery time of a quantity of supplied crop material having at least one supplied material characteristic to be produced by the crop producer;
producing the quantity of supplied crop material to satisfy the sale in the supply contract; and
at the prescribed delivery time, delivering the quantity of supplied crop material to the control tower entity for processing into processed crop products.

wherein the quantity of supplied crop material makes up a portion of an aggregate material supply quantity for processing into an aggregate product sold quantity. As outlined above, the supply contract could specify prescribed crop management practices to be used by the crop producer in production of the quantity of supplied crop material.

One of the problems which could be addressed in the right circumstances with a method of this type is the notion that industrial hemp bracts, leaves and stems when they occur separately are disallowed to be processed or sold as hemp in an any form as they are classified as “controlled substances” by government regulators. Grain is allowed to be processed into a wide range of food derivatives with the only requirement that it contain less than certain amounts of THC, starting with less than 0.3% in the raw materials. In agriculture, grain is defined as anything exceeding 50% or more of the principal grain and less than 50% of other grains, chaff and other biomass materials. The novel idea is that if the grain definition is applied to hemp that the result is that a mixture of hemp grain and biomass either in “bin run” or milled into an inseparable mixture that is not defined by regulators as a “controlled substance”. This enables the industry to access large quantities of raw materials from farmers in a manner that is not prohibited by regulation.

The second component of the industrial hemp control tower is a farmer production contract which is based on the Cannabidiol (CBD) content of the grain. Included are directions for an alteration of the grower management practices related to plant growth stage and amount of a plant growth regulator ethephon applied to the plants to enhance the level of cannabinoids in hemp biomass by 2-9 times normal levels. The state of the art is that this knowledge is known to science and published in peer reviewed journals but has not used to give industrial hemp a cannabinoid production capacity comparable to its' recreational drug cousin marijuana.

The third component is processing of the grain as defined in the first component in its “bin run” state by various traditional means including but not limited to ethanol, supercritical CO2, butane, isopropane, propane, hexane solvent extraction The novel component related to this control tower is the addition to the raw milled grain “raws” of sufficient dimethyl-sulfoxided (DMSO) to yield an extract that has the novel capacity to have bioavailability exceeding that of simple oral ingestion or vaporization of the bioactives for inhalation. Cannabis bioactives, dissolved in DMSO can be formulated into a novel line of human use products designed for oral or transdermal ingestion.

The fourth component is a consumer supply contract known as a “cannabis condominium agreement” written by the individual consumer that takes possession of the bioactives at the farmgate and directs their custom processing and compounding into food and nutraceutical derivative products.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an entity diagram demonstrating the entities involved in the practice of one embodiment of the control tower crop production method outlined herein;

FIG. 2 is a flowchart demonstrating the steps involved in one embodiment of the control tower crop production method of the present invention;

FIG. 3 is an entity diagram demonstrating the entities involved in the practice of another embodiment of the control tower crop production method outlined herein;

FIG. 4 is a flowchart demonstrating the steps involved in another embodiment of the control tower crop production method of the present invention;

FIG. 5 is an entity diagram demonstrating the entities involved in the practice of one embodiment of the method of production of crop material by a crop producer outlined herein;

FIG. 6 is a flowchart demonstrating the steps involved in one embodiment of the method of production of crop material by a crop producer of the present invention;

### DETAILED DESCRIPTION

### Glossary

“DMSO” in this context refers to dimethyl sulfoxide, a solvent used in solvent extraction of crop material fractions and derivatives

“grain” in this context refers to a mixture of seeds and any other crop materials found in a farm field such that the seed fraction exceeds the other materials

“industrial hemp bioactives” in this context refers to any of approximately 300 major and minor terpenes and cannabinoids naturally found in industrial hemp plants

“raws” in this context refers to hemp grain or other crop material that has been harvested into a product that can leave the farm gate for further processing

### Description

As outlined above, the general focus of the present invention is to provide an enhanced product dispenser with the ability to display active advertising content to nearby viewers. The display of active or dynamic advertising content, using cost-effective display equipment or hardware that does not require a substantial installation burden, potentially enhances the revenue outcomes for advertisers while minimizing required cost and resources to install or maintain such equipment.

In addition to a product dispenser which includes the removable active advertising module at the time of installation, there is also disclosed herein a retrofit product approach, which effectively would comprise the manufacture of a replacement dispenser shell for installation onto pre-existing product dispensers which would allow for the attachment of the active advertising module of the present invention.

A method of use of the equipment of the present invention will allow for the display of active advertising content and venues potentially without any cost for equipment installation or retrofit being incurred by the operator of the venue.

### Control Tower Entity

As outlined the invention comprises a control tower crop production method for the production of processed crop products. A control tower production method comprises a production method in which a central entity, or “control tower entity” controls all of the parameters and inputs in a production method to guarantee quality and outcomes from the method.

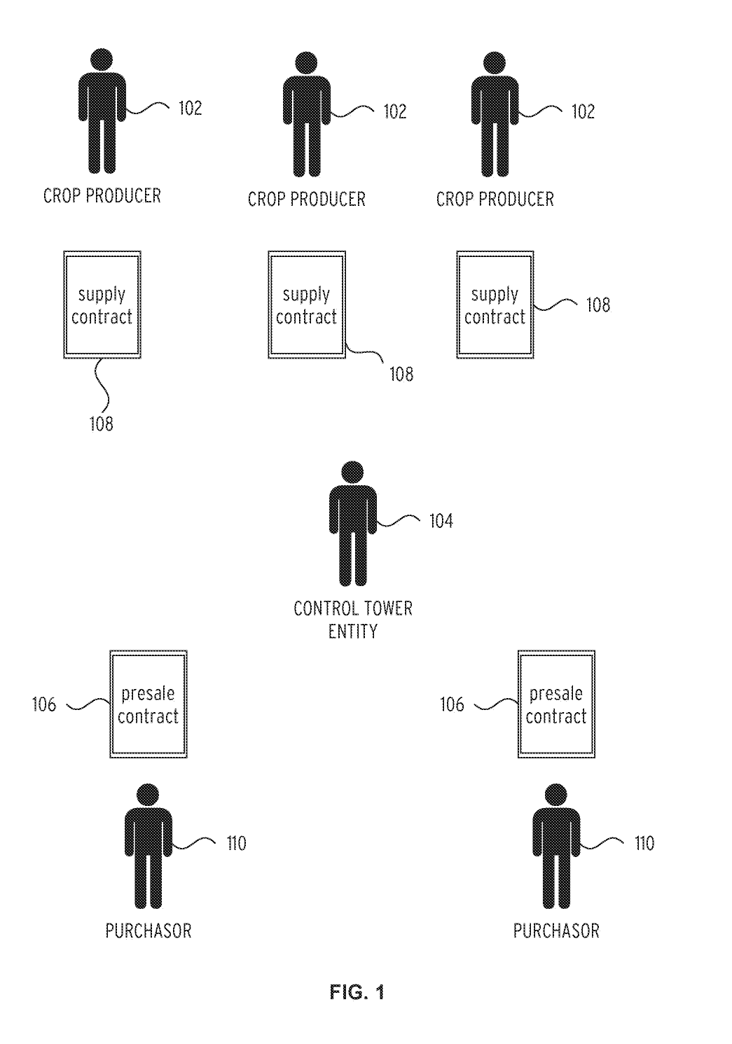

With respect to the control tower crop production method of the present invention, the control tower entity is a central entity responsible for coordinating the steps of the production of processed crop products in accordance with the remainder of the present invention. The control tower entity is an entity effectively acting as the middleman and facilitator between other parties involved in the method. Referring to FIG. 1, Which is an entity diagram demonstrating the parties involved in the practice of one embodiment of the control tower crop production method of the present invention, a control tower entity 104 is shown.

It will be understood that the control tower entity 104 could be any entity capable of facilitating the role of the control tower entity 104 as otherwise outlined herein.

### Crop Producers

The second entity or entities involved in the control tower crop production method are at least one crop producer. Referring again to FIG. 1, crop producer 102 is shown. The crop producer 102 is any entity, likely a farmer, capable of producing the crop material required in the practice of the remainder of the present invention. For example, the method outlined herein in most detail are embodiments of the control tower crop production method for use in the production of processed crop products from hemp grain crop material. The crop producer 102 in this case could be a hemp grain farmer. It will be understood that any agricultural producer capable of producing crop material in the format desired by the control tower entity 104 to facilitate the practice of the remainder of the method of the present invention is contemplated to comprise a crop producer 102 in accordance with the remainder hereof and any such party is contemplated within the scope of the present invention.

The control tower crop production method could be practiced relying as few as a single crop producer 102 to produce crop material, or a far larger plurality of crop producers 102 could also be used. The number of crop producers 102 could vary and any number is contemplated within the scope of the present invention.

Each crop producer 102 will produce and sell crop material to the control tower entity 104 pursuant to a supply contract 108, stipulating quantity of purchase and other conditions as outlined elsewhere herein. Where there is more than one crop producer 102 involved in the particular method, each crop producer 102 might contract for sale of the same type of crop material to the control tower entity 104, or in other cases different types or formats of crop material could be contracted for delivery by one or more crop producer 102. All such combinations are contemplated within the scope hereof.

### Crop Material

As outlined herein the control tower crop production method comprises an early stage step of the formation of at least one supply contract between a control tower entity 104 and a crop producer 102 for the production of a quantity of supplied crop material to have at least one supplied material characteristic, for use as a portion of an aggregate material supply quantity for use in the production of processed crop products therefrom. The crop material is contemplated to be any crop material of a crop which could be used in the production of the desired processed crop products. The crop material could be any particular agricultural crop and could comprise crop material delivered in any particular format desired by the control tower entity 104 for subsequent processing—for example, the crop material might be desired for delivery by the control tower entity 104 from the crop producer 102 as plant seed, plant material, partially processed crop material, or any type of a format which might be desired, and the supply contract 108 between the particular crop producer 102 and the control tower entity 104 would stipulate same.

The control tower entity 104 might as a part of the control tower crop production method contract with one crop producer 102 for the production of different crop material than that acquired from another crop producer 102—the control tower entity 104 might simply wish to acquire an aggregate material supply quantity of crop material from a plurality of crop producers comprising an aggregate material supply quantity of the same crop and same format of crop material, or in other iterations of the control tower crop production method the control tower entity 104 might contract with a different crop producer 102 for the production of crop material of a different crop to be used in the production of processed crop products requiring more than one type of crop material, or even might contract with one crop producer 102 for the delivery of crop material of the same type of crop as another crop producer 102, but to be delivered in a different state or format. It may be the case in even further iterations that individual supply contract 108 with a crop producer 102 could be for the production of a quantity of supplied crop material of the same crop and for delivery in the same format etc., but that certain quantities of crop material to be produced by one crop producer 102 versus another might be desired by the control tower entity 104 to be produced using different prescribed crop management practices—these might also be a variable accommodated in the individual supply contract 108 between the control tower entity 104 and each crop producer 102. All such approaches will be understood by those skilled in the art and are contemplated within the scope hereof.

The crop material could be material of any type of an agricultural crop. It is particularly contemplated that the control tower crop production method of the present invention would be useful in a method of aggregated production of processed crop products from hemp grain, the crop being hemp, but it will also be understood that the entire control tower crop production method of the present invention could be useful in the production of processed crop products from different types of crops altogether, which again will be understood to be within the scope of the invention so long as the overall method is not departed from.

### Supply Contract

Each crop producer 102 will enter into a supply contract 108 to create a sale transaction between themself and the control tower entity 104, for the delivery of a prescribed quantity of supplied crop material having at least one supplied material characteristic, to be delivered at a prescribed delivery time. The determination of the prescribed delivery time by the control tower entity 104, as outlined elsewhere herein, will be done in determining the desired time of delivery of the quantity of supplied crop material as a component of an aggregate material supply quantity which will be processed to produce an aggregate product sold quantity. The supply contract 108 would likely outline monetary or other consideration exchanged between the parties etc. As outlined above, the supply contract 108 would also stipulate particular at least one supplied material characteristic for the quantity of supplied crop material.

Any type of a supply contract 108 which accomplishes the objective of cementing a purchase transaction for the delivery of a quantity of supplied crop material at a prescribed delivery time, said quantity of supplied crop material having at least one supplied material characteristic, is contemplated within the scope hereof. There may be many types of financial models accomplished by such supply contract 108 as well and any such model or approach is contemplated within the scope of the present invention as well.

### Prescribed Delivery Time

As outlined above, one of the key elements of the method of control tower crop production method of the present invention is the stipulation of a prescribed delivery time in respect of each supply contract 108. By prescribing the delivery time for the quantity of supplied crop material for each supply contract 108, the control tower entity 104 can ensure that they have the necessary aggregate material supply quantity of crop material assembled in time to allow for the processing of the quantity of processed crop products to be produced therefrom. The prescribed delivery time might be the same for each supply contract 108, or in other more elaborate logistical approaches, the prescribed delivery time for different supply contracts might be staggered. Any such approach which will result in the timely assembly of the aggregate material supply quantity will be understood to be contemplated within the scope of the present invention.

### Supplied Material Characteristics

As outlined throughout, in addition to stipulating the prescribed delivery time for a quantity of supplied crop material from the crop producer 102 to the control tower entity 104, the supply contract 108 would also stipulate at least one supplied material characteristic of the quantity of supplied crop material to be delivered. One of the key elements of the control tower crop production method herein is that all key elements of active ingredient content and crop material quantity etc. are controlled by the control tower entity 104, and specifying certain at least one supplied material characteristic in the supply contract 108 is another key element of such control. For example the supply contract 108 might stipulate a particular quality of the crop material to be delivered, a particular range of active ingredient therein, a particular style or format for delivery of the quantity of supplied crop material, or really any one of a large number of additional product parameters. Any type of at least one supplied material characteristic which could be specified for crop material such as is intended to be delivered under the supply contract 108 are contemplated within the scope hereof. The supply contract 108 might even stipulate in certain circumstances the delivery of multiple groupings of crop material having different at least one supplied material characteristic which will also be understood to be within the scope hereof.

Each supply contract 108 might stipulate one or more supplied crop material characteristics.

### Prescribed Crop Management Practices

As outlined herein, in addition to specifying the prescribed delivery time and the at least one supplied material characteristic, the supply contract 108 might also stipulate prescribed crop management practices for use by the crop producer 102 in the production of the quantity of supplied crop material. It will be understood that any number and type of prescribed crop management practices might be desired to be used in the production of crop material for the control tower entity 104. The control tower entity 104 might stipulate the same prescribed crop management practices for each crop producer 102 and each supply contract 108, or different prescribed crop management practices might be used for at least one crop producer 102 based either on the desired at least one supplied material characteristic, or based on the growing environment of that crop producer 102 etc. Any types of prescribed crop management practices are contemplated within the scope of the present invention.

Crop management practices which might be prescribed for use in a supply contract 108 and the control tower crop production method herein include, but are not limited to:
treating the planting seeds and spraying the growing crop foliage with at least one plant growth regulator;
specifying the harvest timing for the crop material;
swathing the crop stock and drying the swath in advance of further harvest processing to minimize time/temperature dependent spoilage;
using harvesting equipment to gather only the heads of the crop plants into bulk containers in the field for further processing;
harvesting plant material or grain using a combine harvester set to remove only the plant stalks from the remainder of the crop material for return to the field;
delivery of aggregated bin run hemp grain material as crop material.

As outlined above, many different types of crops are contemplated to potentially be used within the scope of the control tower crop production method of the present invention, but one source of crop material, from which processed crop products will be generated, is hemp grain. Where the crop material to be used is hemp grain, the prescribed crop management practices might be selected from, but are not limited to:
treating the planting seeds and spraying the growing crop foliage with at least one plant growth regulator;
specifying the harvest timing for the crop material such that the weight of oilseed meat to hemp grain plant matter exceeds 50.1%;
swathing the hemp crop stock and drying the swath in advance of further harvest processing to minimize time/temperature dependent spoilage;
using harvesting equipment to gather only the heads of the hemp plants into bulk containers in the field for further processing;
harvesting the hemp grain using a combine harvester set to remove only the hemp plant stalks from the remainder of the crop material for return to the field;
delivery of aggregated bin run hemp grain material as crop material.

Any number of different types of crop management practices can be understood to be within the scope of those outlined herein. Crop management practices might include seed treatment or field preparation techniques, treatment of the growing client matter in the field, or the maintenance of particular parameters around harvesting or different types of harvesting methods. These are all contemplated within the scope hereof.

### Purchasors

In addition to the at least one crop producer 102, the control tower crop production method is also reliant upon at least one purchasor. Each purchasor 110 is interested in the purchase of a quantity of processed crop products made from crop material in accordance with the remainder of the invention, and enters into a presale contract 106 with the control tower entity 104 for the purchase of the desired quantity of processed crop products from the control tower entity 104. The quantity of processed crop products which the purchasor 110 wishes to buy would be processed crop products derived at least in part from crop material obtained from at least one crop producer 102 pursuant to a supply contract 108 hereunder.

The control tower crop production method could be practiced with only one purchasor 110, or a plurality of purchasors 110 could be involved. Each purchasor 110 could enter into a presale contract 106 for the purchase of the same type of processed crop products, or each purchasor 110 could contract for different quantities, types or formats of processed crop products to be produced from the crop material.

### Processed Crop Products

The quantity of processed crop products which the purchasor 110 wishes to buy would be processed crop products derived at least in part from crop material obtained from at least one crop producer crop producer 102 pursuant to a supply contract 108 hereunder.

In most cases, the processed crop products which a purchasor 110 would seek to purchase from the control tower entity 104 would be crop material fractions or crop material derivatives—fractions or derivatives of the crop material in question will all be understood to be processed crop products within the scope of the remainder of the invention. Extracts or derivatives of the crop material could also be compounded into more complex multi-ingredient products and such added steps and types of processed crop products are also contemplated within the present invention.

Each purchasor 110 may wish to buy a quantity of the sme type of processed crop products, or in some embodiments of the control tower crop production method the control tower entity 104 could produce multiple types or formats of processed crop products from the source crop material, and the production of multiple types of processed crop products relying on at least one similar base crop material is intended within the scope hereof.

### Prescribed Product Characteristics

The control tower crop production method requires that each quantity of supplied crop material have prescribed at least one supplied material characteristic, and similarly will stipulate in each presale contract 106 at least one at least one sold product characteristic. The at least one sold product characteristic could be a format or size dictated by the purchasor 110 for the final processed crop product(s), or might be some other type of a characteristic including a particular volume of an active ingredient, a particular processing step or style having been used in the production of same etc. As in the case of the at least one supplied material characteristic, the at least one sold product characteristic could come from a very broad range of parameters which will be understood to those skilled in the art of crop processing or the end processed crop products and any characteristic or parameter which can be stipulated with respect to the production or final qualities of the processed crop products is contemplated within the scope of the present invention.

### Presale Contract

Each purchasor 110 will also enter into a presale contract 106 with the control tower entity 104, to create a presale transaction between themself and the control tower entity 104 for the purchase when available and completed of a prescribed quantity of processed crop products having at least one sold product characteristic. The presale contract 106 will also outline the at least one sold product characteristic for the processed crop products sold thereunder—for example active ingredient content, product format or the like, as outlined as options elsewhere herein. As outlined, the method could be practiced with one or more than one purchasor 110. Each purchasor 110 will enter into a presale contract 106 with the control tower entity 104.

The presale contract 106 might also specify a delivery time for the delivery of the quantity of processed crop products in some cases. The presale contract 106 will outline the details of a commercial product sale transaction between the purchasor 110 and the control tower entity 104. The quantity of processed crop products contracted in the presale contract 106 will form a portion of the aggregate product sold quantity.

Any type of a presale contract 106 which accomplishes the objective of cementing a purchase transaction for the delivery of a quantity of processed crop products, said quantity of processed crop products having at least one sold product characteristic, is contemplated within the scope hereof. There may be many types of financial models accomplished by such presale contract 106 as well and any such model or approach is contemplated within the scope of the present invention as well.

The presale contract 106 might also be referred to in some embodiments as a “condominium contract”—being a presale contract 106 between a purchasor 110 and a control tower entity 104 for processed crop products and the supply chain that allows the consumer to direct when, how and in what form the finished product will be delivered to them in as well as what additional components will be custom compounded into the processed crop products of their choosing.

### Aggregate Material Supply Quantity

There are two key aggregation concepts which are important in the overall control tower crop production method of the present invention. The first of these is the aggregate material supply quantity and the second is the aggregate product sold quantity.

The aggregate material supply quantity represents the total quantity of the quantity of supplied crop material for all of the supply contracts. The aggregate material supply quantity may be a singular volume, or may represent multiple aggregate required supply volumes where more than one type of crop material, or crop material of varying at least one sold product characteristic is required. The aggregate material supply quantity is the amount of crop material which is required by the control tower entity 104 to process and produce the total amount of processed crop products required under all of the presale contracts.

### Aggregate Product Sold Quantity

The aggregate product sold quantity represents the total of the quantity of processed crop products required for delivery under all of the presale contracts. This might be one processed crop product, or multiple products—the aggregate product sold quantity concept represents the required amounts of finished product in either situation.

The aggregate product sold quantity is important since the aggregate material supply quantity contracted for by the control tower entity 104 is a sufficient amount to produce the aggregate product sold quantity. This is an element of the overall control tower crop production method.

In certain embodiments of the control tower crop production method, the number of presale contracts entered into with purchasors would be selected based upon the aggregate material supply quantity—i.e. the control tower entity 104 would only contract for the amount of processed crop products which they can produce with available inventory of crop material, Alternatively the process can be determined from the demand end also, wherein the number of supply contracts entered into would be sufficient to secure an aggregate material supply quantity sufficient to produce the aggregate product sold quantity required based on presale contracts in hand by the control tower entity 104. Both such approaches to the aggregation concept and matching of the aggregate product sold quantity and the aggregate material supply quantity are contemplated within the scope hereof.

### Processing Entities

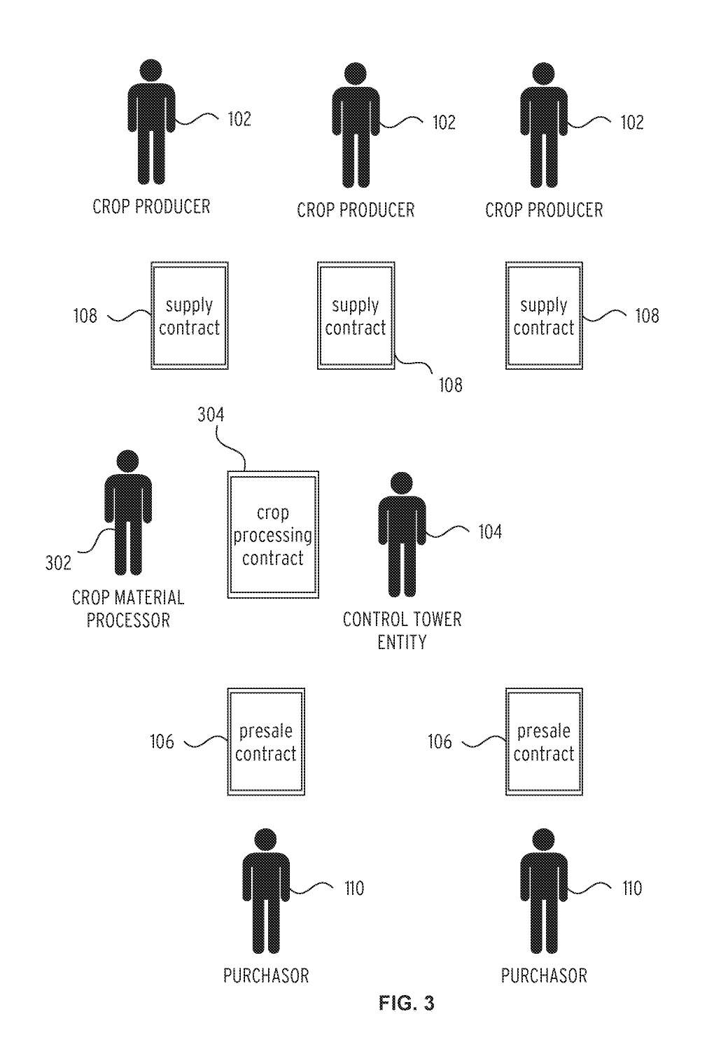

As outlined in the claims enclosed herein, the control tower entity 104 would, following delivery of the aggregate material supply quantity, process the aggregate material supply quantity along with whatever necessary products or ingredients were required into the aggregate product sold quantity of processed crop products. The control tower entity 104 might themselves conduct the processing step, or might alternatively contract with at least one processor to undertake the processing and production step. A crop material processor 302 is shown in the entity diagram of FIG. 3. Where the control tower entity 104 uses outside processing help to conduct the processing of the aggregate material supply quantity and the production of the required processed crop products in the aggregate product sold quantity, one crop material processor 302 might conduct all of that work, or more than one crop material processor 302 might be used where more than one type of finished processed crop products were being made. The control tower entity 104 might even conduct some of the processing internally and contract with at least one crop material processor 302 to provide partial assistance. Each crop material processor 302 would contract with the control tower entity 104 pursuant to a crop processing contract 304—in terms of locking down the parameters of the processing and any requirements etc. to be imposed by the control tower entity 104.

### Processing the Crop Material

Plant material can be fractionated or otherwise processed into processed crop products in may different ways. The step of processing of the aggregate material supply quantity into the processed crop products could, for example, be done using at least one the following methods:
air or mechanical fractionation of crop material based on active ingredient concentrations;
threshing raw plant material to separate remaining stalks, and macerating remaining raw crop fraction into particulate for further processing;
crushing crop material for oil;
heating grain to a temperature between the heat of vaporization and heat of decomposition of an ingredient therein, to generate a vapor that is condensed into a purified fraction and a spent grain fraction which is depleted of the ingredient; or
solvent extraction of derivatives from the crop material.

In the case of the crop material from which processed crop products are being produced being hemp grain, some examples of processing steps which could be undertaken include the following:
air or mechanical fractionation of crop material based hemp bioactive concentrations;
threshing raw plant material to separate remaining stalks, and macerating remaining raw crop fraction into particulate for further processing;
crushing crop material for oil, said oil having a higher CBD concentration than spent crushed hemp grain;
heating the hemp grain to a temperature between the heat of vaporization and heat of decomposition of CBD, to generate a vapor that is condensed into a purified CBD fraction and a spent hemp grain fraction which is depleted of CBD; or
solvent extraction of derivatives from the crop material.

Where solvent extraction was used as a step in the processing, DMSO could be used as the solvent. Other solvents could also be used.

It will be understood that virtually any type of processing step which could be applied to a portion of the aggregate material supply quantity for the purpose of preparing or processing processed crop products representing at least a portion of the aggregate product sold quantity therefrom are contemplated within the scope of the present invention.

### General Method Overview—Control Tower Crop Production Method

As outlined herein the invention comprises a control tower crop production method for the production of processed crop products from crop material. There are many different embodiments of a control tower crop production method with the scope hereof.

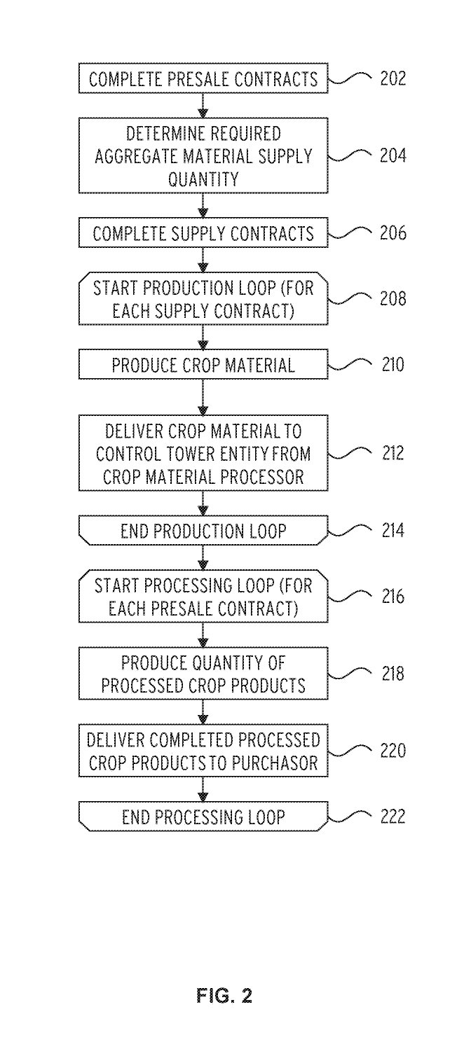

FIG. 1 and FIG. 2 are an entity diagram and a flow chart demonstrating a first grouping of elements and steps to practice one embodiment of the control tower crop production method of the present invention. As shown in the entity network of FIG. 1, there is a control tower entity 104. The control tower entity 104 is the central “hub” or party controlling the control tower crop production method. The control tower entity 104 has at least one supply contract 108 with a corresponding crop producer 102—in this FIG. 3, three supply contract 108 are shown each with a corresponding crop producer 102. As outlined above, the crop producer 102 will contract pursuant to a supply contract 108 with the control tower entity 104 to deliver a quantity of supplied crop material having at least one supplied material characteristic to the control tower entity 104 at a prescribed delivery time.

Also shown in the entity network of FIG. 2 is at least one purchasor 110 for a quantity of processed crop products, connected to the control tower entity 104 by a presale contract 106. In this Figure, there are shown two purchasor 110 with corresponding presale contract 106.

In practice of the method of FIG. 2, block 202 shows the completion of the at least one presale contract 106, each presale contract 106 with a separate purchasor 110. In the embodiment of the control tower crop production method showin in this Figure, the completion of presale contracts at block 202 is first shown, and upon completion of the presale contracts, the aggregate product sold quantity is determined based on the amounts and types of processed crop products sold in the presale contracts. Based upon the calculation of the aggregate product sold quantity, the aggregate material supply quantity required of the crop material in question can be determined. Calculation of the aggregate product sold quantity is shown at block 204.

Shown next at block 206, the control tower entity 104 then enters into at least one supply contract 108 (or in this case three) each with a crop producer 102 for supply of a quantity of supplied crop material. The quantity of supplied crop material for each supply contract 108, when aggregated, equals the aggregate material supply quantity and equals the amount of crop material required in processing to produce the aggregate product sold quantity of processed crop products. Each supply contract 108 stipulates at least one supplied material characteristic and a prescribed delivery time for the quantity of supplied crop material contracted therein.

A production loop is then shown at opening loop block 208—basically in respect of each supply contract 108 the quantity of supplied crop material is produced by the crop producer 102—block 210—and delivered to the control tower entity 104—block 212. The production loop closes at closing loop block 214. The loop shown between opening loop block 208 and closing loop block 214 would not necessarily take place sequentially or in direct parallel, but the loop shown is intended to demonstrate that for each supply contract 108 the production of the quantity of supplied crop material contracted for thereunder is produced, having the at least one supplied material characteristic and delivered to the control tower entity 104 at the prescribed delivery time such that following completion of all of these deliveries the control tower entity 104 would be in possession of the aggregate material supply quantity of crop material.

There is next shown in this embodiment a processing loop beginning at opening loop block 216. The processing loop represents the production of the contracted processed crop products for each presale contract 106, being in total the aggregate product sold quantity. The quantity of processed crop products contracted under the presale contract 106 is completed, shown at block 218, and delivered to the purchasor 110 at block 220. The processing loop closes at closing loop block 222. Again as in the case of the production loop, the processing loop would not necessarily take place in sequence or parallel—if the entire aggregate product sold quantity was a single type and format of product, the entire aggregate product sold quantity for the entire inventory of presale contract 106 could be completed in one pass of this loop—in other cases where different types of processed crop products are included within the aggregate product sold quantity those might be produced on a by-contract or by-product basis. Any such iteration of the production of the processed crop products is contemplated within the scope hereof.

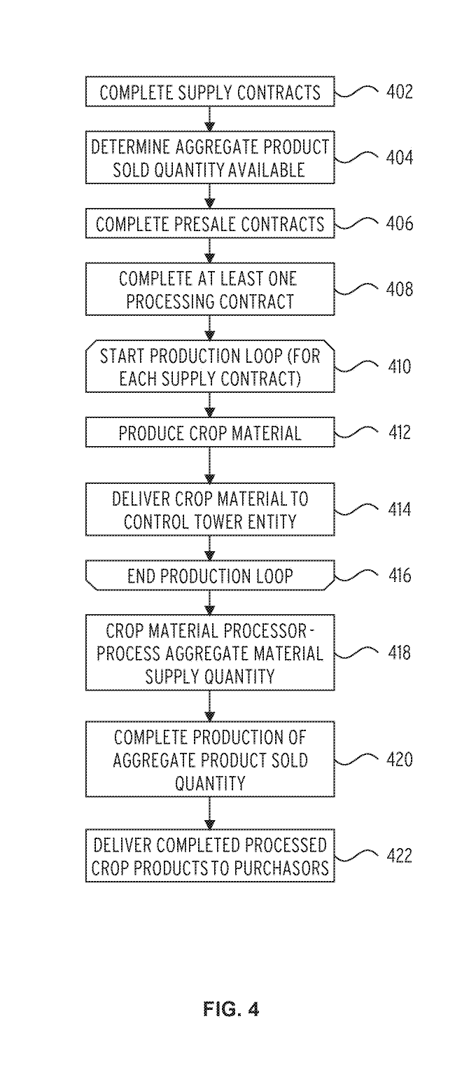

A second embodiment of the control tower crop production method is shown in FIG. 3 and FIG. 4. FIG. 3 is the entity diagram of the parties involved in this particular iteration of the control tower crop production method. It is the same as the entities shown in FIG. 1 except that a crop material processor 302 and a related crop processing contract 304 are shown. In this embodiment, the control tower entity 104 has entered into a crop processing contract 304 with a crop material processor 302 to provide assistance in the processing of the aggregate material supply quantity into the aggregate product sold quantity.

The method of the present invention conducted by the entity network of FIG. 3 is shown in FIG. 4. In this embodiment of the control tower crop production method, the first step is the completion of at least one supply contract 108 with a crop producer 102, shown at block 402. In this case, three crop producer 102 with corresponding supply contract 108 are shown.

Once the control tower entity 104 has entered into any desired supply contract 108, they can calculate the aggregate material supply quantity available, shown at block 404, and extrapolate from that aggregate material supply quantity and the types of processed crop products desired, the aggregate product sold quantity which they can sell.

Based on the calculated aggregate product sold quantity, the control tower entity 104 can then enter into at least one presale contract 106 with a purchasor 110 for the sale of a quantity of processed crop products. The aggregate product sold quantity and amounts of processed crop products available for sale are determined to a degree by the aggregate material supply quantity available. Completion of the at least one presale contract 106 is shown at block 408.

A production loop is then shown at opening loop block 410—basically in respect of each supply contract 108 the quantity of supplied crop material is produced by the crop producer 102—block 412—and delivered to the control tower entity 104—block 414. The production loop closes at closing loop block 416. The loop shown between opening loop block 410 and closing loop block 416 would not necessarily take place sequentially or in direct parallel, but the loop shown is intended to demonstrate that for each supply contract 108 the production of the quantity of supplied crop material contracted for thereunder is produced, having the at least one supplied material characteristic and delivered to the control tower entity 104 at the prescribed delivery time such that following completion of all of these deliveries the control tower entity 104 would be in possession of the aggregate material supply quantity of crop material.

The crop material processor 302 then processes the aggregate material supply quantity to produce the contracted processed crop products for each presale contract 106, being in total the aggregate product sold quantity. The quantity of processed crop products contracted under the presale contract 106 is completed, shown at block 418 through block 420, and delivered to the purchasor 110 at block 422. Again as in the case of the production loop, the processing would not necessarily take place in sequence or parallel—if the entire aggregate product sold quantity was a single type and format of product, the entire aggregate product sold quantity for the entire inventory of presale contract 106 could be completed in one pass of this loop—in other cases where different types of processed crop products are included within the aggregate product sold quantity those might be produced on a by-contract or by-product basis. Any such iteration of the production of the processed crop products is contemplated within the scope hereof.

### Method of Production of Crop Material by a Crop Producer

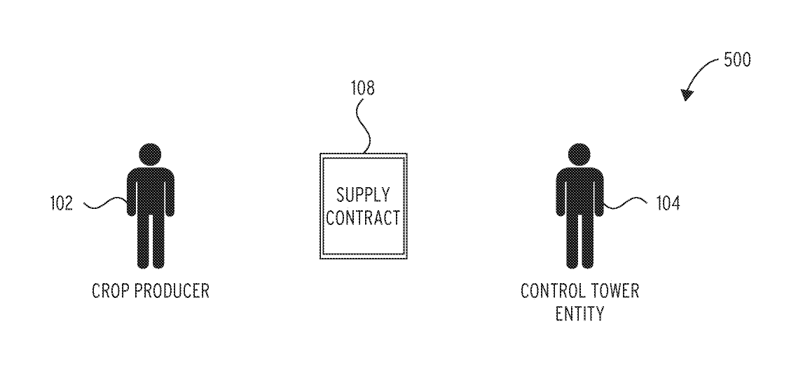

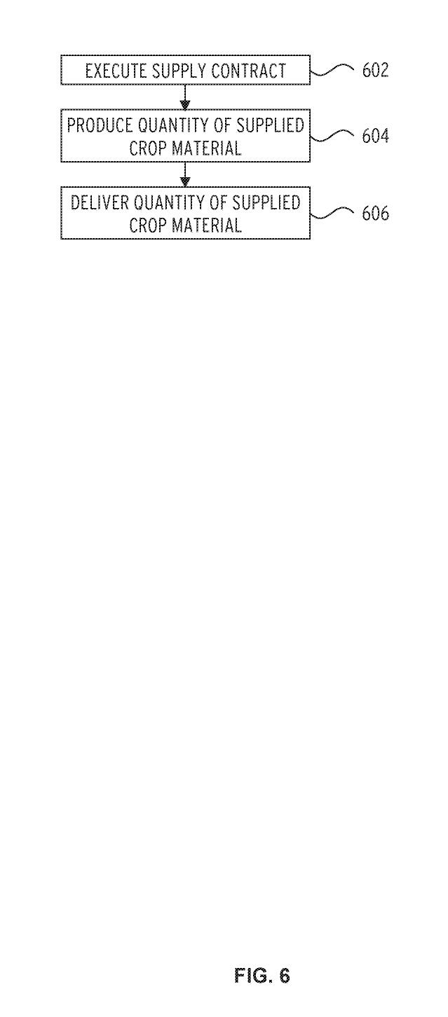

In addition to the control tower crop production method demonstrated, the present invention also includes a method of production of crop material by a crop producer for use in a control tower crop production method such as outlined herein. FIG. 5 and FIG. 6 are an entity diagram and flowchart demonstrating one embodiment of the method of production of crop material by a crop producer.

The method of production of crop material by a crop producer in accordance with this invention comprises the establishment of a delivery transaction between a single crop producer 102 and a control tower entity 104, such entities being shown in FIG. 5. The crop producer 102 and the control tower entity 104 enter into a supply contract 108 for the delivery of a prescribed quantity of supplied crop material for delivery at a prescribed delivery time. The supply contract 108 will also specify at least one supplied material characteristic for the quantity of supplied crop material to be delivered—the at least one supplied material characteristic might be any type of at least one supplied material characteristic that it was desired to guarantee in the delivered crop material, including parameters around content of one or more ingredients or any other type of at least one supplied material characteristic otherwise outlined herein and as will be understood by those skilled in the art of crop production.

The supply contract 108 might also stipulate prescribed crop management practices to be used by the crop producer 102 in the production of the quantity of supplied crop material. As in the case of the at least one supplied material characteristic, the prescribed crop management practices could be any type of crop management practices desired to be implemented by the control tower entity 104 in the production of the quantity of supplied crop material, either to ensure a particular quality or other aspect of the quantity of supplied crop material—any crop management practices including the use of particular seed or plant treatments, agronomic or cropping practices, harvesting practices, or any other such approaches will be understood by those skilled in the art of agricultural crop production and all such prescribed crop management practices are contemplated within the scope hereof.

The entry into a supply contract 108 between a crop producer 102 and a control tower entity 104, being the first step of the method of production of crop material by a crop producer, is shown at block 602 of FIG. 6.

Following the completion of the supply contract 108 for delivery of the quantity of supplied crop material, between the crop producer 102 and the control tower entity 104, the next step in the method of production of crop material by a crop producer is the production of the quantity of supplied crop material by the crop producer 102, shown at block 604. The growing or production of the quantity of supplied crop material would be done using any prescribed crop management practices, for delivery of the quantity of supplied crop material at the prescribed delivery time. On arrival of the prescribed delivery time, the crop producer 102 will deliver the quantity of supplied crop material to the control tower entity 104, for subsequent processing into an aggregate product sold quantity of processed crop products, as a part of an aggregate material supply quantity of crop material.

The quantity of supplied crop material delivered to the control tower entity 104 by the crop producer 102, shown at block 606, concludes the method of production of crop material by a crop producer for use in a control tower crop production method such as otherwise outlined herein.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A control tower crop production method for the production by a control tower entity of processed crop products from crop material, said method comprising the control tower entity:
entering into at least one presale contract for the sale and delivery to at least one purchasor of a quantity of processed crop products having at least one sold product characteristic, the aggregate of the quantity of processed crop products for all of the presale contracts being the aggregate product sold quantity;
entering into at least one supply contract with at least one crop producer for the production and delivery to the control tower entity at a prescribed delivery time of a quantity of supplied crop material having at least one supplied material characteristic, the aggregate of the quantity of supplied crop material for all of the supply contracts being the aggregate material supply quantity;
in respect of each supply contract, accepting delivery of the quantity of supplied crop material from the at least one crop producer at the prescribed delivery time;
upon completion of delivery and acceptance of the aggregate material supply quantity:
processing the crop material into processed crop products with the at least one supplied material characteristic required by each of the at least one presale contract; and
delivering of the processed crop products for each presale contract to the corresponding purchasor;
wherein the aggregate material supply quantity contracted for with the at least one crop producer is a sufficient quantity of supplied crop material having adequate at least one supplied material characteristic to produce the aggregate product sold quantity of processed crop products.

2. The control tower crop production method of claim 1 wherein a supply contract specifies prescribed crop management practices to be used by the at least one crop producer in production of the quantity of supplied crop material.

3. The control tower crop production method of claim 1 wherein the at least one supplied material characteristic for the crop material sold under a supply contract includes a prescribed range of content of an active ingredient therein.

4. The control tower crop production method of claim 1 wherein the at least one supplied material characteristic for the crop material sold under a supply contract includes a prescribed threshold value for the content of an active ingredient therein.

5. The control tower crop production method of claim 4 wherein the active ingredient content in the crop material does not exceed the threshold value.

6. The control tower crop production method of claim 4 wherein the active ingredient content in the crop material is not lower than the threshold value.

7. The control tower crop production method of claim 1 wherein the at least one sold product characteristic for the processed crop products sold pursuant to a presale contract include a prescribed quantity of an active ingredient from the crop material to be contained in the processed crop products.

8. The control tower crop production method of claim 1 wherein the processing of the crop material into the processed crop products comprises:
fractionating the crop material into a plurality of midstage fractions which can be further processed into processed crop products; and
refining the midstage fractions to yield the quantity of processed crop products with the desired at least one sold product characteristic.

9. The control tower crop production method of claim 1 further comprising the step of the control tower entity entering into at least one processing contract with at least one processor for the processing of crop material into processed crop products, wherein the processing of at least a portion of the aggregate material supply quantity into at least a portion of the aggregate product sold quantity is done by said at least one processor.

10. The control tower crop production method of claim 1 wherein the presale contracts are completed in advance of the completion of the supply contracts, and the number of supply contracts and the details of the at least one supplied material characteristic of the aggregate material supply quantity required is selected based on the quantity and quality of the aggregate product sold quantity sold by the control tower entity under the presale contracts.

11. The control tower crop production method of claim 1 wherein the supply contracts are completed in advance of the completion of the presale contracts, and the number of presale contracts and the aggregate product sold quantity is selected based upon the quantity and quality of the aggregate material supply quantity available to the control tower entity under the supply contracts.

12. The control tower crop production method of claim 1 wherein the number of supply contracts is more than one.

13. The control tower crop production method of claim 1 wherein the number of presale contracts is more than one.

14. The control tower crop production method of claim 1 wherein the crop material is plant matter.

15. The control tower crop production method of claim 14 wherein the plant matter is plant seed.

16. The control tower crop production method of claim 15 wherein the crop material is hemp grain.

17. The control tower crop production method of claim 16 wherein the processing of the aggregate material supply quantity into the processed crop products is done using at least one the following methods:
air or mechanical fractionation of crop material based hemp bioactive concentrations; threshing raw plant material to separate remaining stalks, and macerating remaining raw crop fraction into particulate for further processing;
crushing crop material for oil, said oil having a higher CBD concentration than spent crushed hemp grain;
heating the hemp grain to a temperature between the heat of vaporization and heat of decomposition of CBD, to generate a vapor that is condensed into a purified CBD fraction and a spent hemp grain fraction which is depleted of CBD; or
solvent extraction of derivatives from the crop material;

18. The control tower crop production method of claim 1 wherein at least some of the processed crop products sold to a purchasor in a supply contract are crop material fractions.

19. The control tower crop production method of claim 1 wherein at least some of the processed crop products sold to a purchasor in a supply contract are crop material derivatives.

20. The control tower crop production method of claim 19 wherein the production of crop material derivatives comprises the solvent extraction of the crop material derivatives from the related quantity of crop material.

21. The control tower crop production method of claim 20 wherein at least a portion of the solvent used in the solvent extraction process is left in the related quantity of finished crop material derivatives.

22. The control tower crop production method of claim 21 wherein the solvent the solvent extraction process is dimethyl sulfoxide.

23. The control tower crop production method of claim 16 wherein a supply contract specifies prescribed crop management practices to be used by the producer in production of the crop material, to result in crop material with at least one supplied material characteristic.

24. The control tower crop production method of claim 23 wherein the prescribed crop management practices are selected from at least one of:
treating the planting seeds and spraying the growing crop foliage with at least one plant growth regulator;
specifying the harvest timing for the crop material such that the weight of oilseed meat to hemp grain plant matter exceeds 50.1%;
swathing the hemp crop stock and drying the swath in advance of further harvest processing to minimize time/temperature dependent spoilage;
using harvesting equipment to gather only the heads of the hemp plants into bulk containers in the field for further processing;
harvesting the hemp grain using a combine harvester set to remove only the hemp plant stalks from the remainder of the crop material for return to the field;
delivery of aggregated bin run hemp grain material as crop material.

25. (canceled)

26. A method of production of crop material by a crop producer for use in a control tower crop production method for the production of processed crop products from crop material, said method comprising the crop producer:
entering into a supply contract with a control tower entity for the sale and delivery to the control tower entity at a prescribed delivery time of a quantity of supplied crop material having at least one supplied material characteristic to be produced by the crop producer;
producing the quantity of supplied crop material to satisfy the sale in the supply contract;
at the prescribed delivery time, delivering the quantity of supplied crop material to the control tower entity for processing into processed crop products;
wherein the quantity of supplied crop material makes up a portion of an aggregate material supply quantity required for processing into a predetermined aggregate product sold quantity.

27. The method of production of crop material by a crop producer of claim 26 wherein the supply contract specifies prescribed crop management practices to be used by the crop producer in production of the quantity of supplied crop material.

28. The method of production of crop material by a crop producer of claim 26 wherein the at least one supplied material characteristic for the crop material sold under the supply contract includes a prescribed range of content of an active ingredient therein.

29. The method of production of crop material by a crop producer of claim 26 wherein the at least one supplied material characteristic for the crop material sold under the supply contract includes a prescribed threshold value for the content of an active ingredient therein.

30. The method of production of crop material by a crop producer of claim 29 wherein the active ingredient content in the crop material does not exceed the threshold value.

31. The method of production of crop material by a crop producer of claim 29 wherein the active ingredient content in the crop material is not lower than the threshold value.

32. The control tower crop production method of claim 26 wherein the crop material is plant matter.

33. The control tower crop production method of claim 32 wherein the plant matter is plant seed.

34. The control tower crop production method of claim 33 wherein the crop material is hemp grain.
